(19) United States
(12) Patent Application Publication
(10) Pub. No.: US 2025/0306587 A1
(43) Pub. Date: Oct. 2, 2025

(54) WORKING SYSTEM

(71) Applicant: HONDA MOTOR CO., LTD., Tokyo (JP)

(72) Inventors: Jun Yoshikawa, Wako-shi (JP); Lei Yuan, Tokyo (JP)

(21) Appl. No.: 19/066,554

(22) Filed: Feb. 28, 2025

(30) Foreign Application Priority Data
Mar. 28, 2024 (JP) 2024-053420

(51) Int. Cl. G05D 1/224; G05D 1/622; G05D 1/86; G05D 109/10; G05D 111/10; G05D 111/20; G05D 111/30; G05D 111/50; G06Q 30/0207

(52) U.S. Cl. CPC G05D 1/2249; G05D 1/622; G05D 1/86; G06Q 30/0207; G05D 2109/10; G05D 2111/10; G05D 2111/20; G05D 2111/32; G05D 2111/54

(57) ABSTRACT

A working system can perform work by a working mobile body remotely operated by a user, and includes an image generation unit configured to generate a virtual space image corresponding to a real space around the working mobile body, and a head-mounted display configured to be worn by the user and give the user the virtual space image generated by the image generation unit. The image generation unit generates the virtual space image corresponding to the position and direction of the working mobile body.

### CROSS-REFERENCE TO RELATED APPLICATIONS

This application is based upon and claims the benefit of priority from Japanese Patent Application No. 2024-053420 filed on Mar. 28, 2024, the contents of which are incorporated herein by reference.

### BACKGROUND OF THE INVENTION

### Field of the Invention

The present disclosure relates to a working system.

### Description of the Related Art

JP 6232649 B2 discloses a virtual space display system. In this system, a passenger of a vehicle that is automatically driven wears a head-mounted display. The head-mounted display displays a virtual space image different from the actual environment around the vehicle, to a passenger of the vehicle.

### SUMMARY OF THE INVENTION

JP 6232649 B2 merely discloses that the virtual space image is displayed. Recently, it has been desired to provide a satisfactory working system.

The present invention has the object of solving the aforementioned problem.

A working system according to one aspect of the present disclosure is configured to perform a work by a working mobile body remotely operated by a user, and includes an image generation unit configured to generate a virtual space image corresponding to a real space around the working mobile body, and a head-mounted display configured to be worn by the user and provide the user with the virtual space image generated by the image generation unit, wherein the image generation unit generates the virtual space image corresponding to a position and a direction of the working mobile body.

According to the present invention, it is possible to provide a satisfactory working system.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a working system according to a first embodiment;

FIG. 2 is a functional block diagram of a controller according to the first embodiment;

FIG. 3 is a functional block diagram of a working mobile body according to the first embodiment;

FIG. 4 is a functional block diagram of a management device according to a first embodiment;

FIG. 5 is a functional block diagram of the head-mounted display according to the first embodiment;

FIG. 6 is a sequence diagram relating to the operation of the working mobile body;

FIG. 7 is a sequence diagram relating to the display of a virtual space image;

FIG. 8A is a diagram illustrating a real space image;

FIG. 8B is a diagram illustrating a virtual space image;

FIG. 9 is a functional block diagram of a management device according to a second embodiment;

FIG. 10 is a functional block diagram of a management device according to a third embodiment;

FIG. 11 is a functional block diagram of a management device according to a fifth embodiment;

FIG. 12 is a functional block diagram of a management device according to a sixth embodiment;

FIG. 13 is a functional block diagram of a working mobile body according to the seventh embodiment; and

FIG. 14 is a schematic configuration diagram of a communication system according to an eighth embodiment.

### DETAILED DESCRIPTION OF THE INVENTION

A remotely operable working mobile body for light work (for example, a self-propelled vacuum cleaner, a self-propelled lawn mower, or the like) has been developed. The user performs work by remotely operating the working mobile body with a controller. By using a virtual space image for this work, the user can enjoy the work. An embodiment will be specifically described below.

### 1 First Embodiment

### 1-1 Configuration of Working System 10

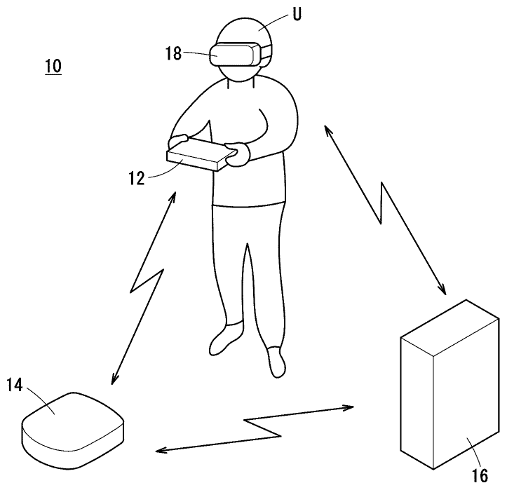

FIG. 1 is a schematic configuration diagram of a working system 10 according to a first embodiment. The working system 10 includes a controller 12, a working mobile body 14, a management device 16, and a head-mounted display 18. The working mobile body 14 performs a predetermined work (cleaning, mowing of lawn, etc.) while moving. A user U uses the controller 12 to remotely operate the working mobile body 14. The user U may wear the head-mounted display 18 during remote operation of the working mobile body 14. The head-mounted display 18 provides the user U with a virtual space image corresponding to the position and orientation of the working mobile body 14. Consequently, the user U can perform the work in the real space while experiencing the virtual space.

In the working system 10, the devices can perform wireless communication with each other. For example, the controller 12 and the working mobile body 14 can perform wireless communication with each other. The working mobile body 14 and the management device 16 can perform wireless communication with each other. The management device 16 and the head-mounted display 18 can perform wireless communication with each other.

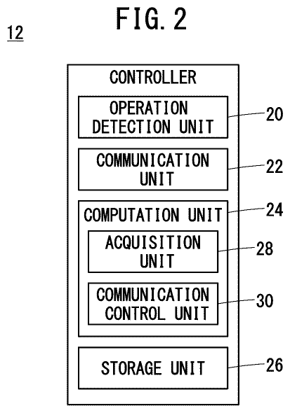

FIG. 2 is a functional block diagram of the controller 12 according to the first embodiment. The controller 12 is a remote controller for operating the working mobile body 14. The controller 12 is operated by the user U. The controller 12 includes an operation detection unit 20, a communication unit 22, a computation unit 24, and a storage unit 26.

The operation detection unit 20 may be constituted by, for example, operating elements (a lever, a button, etc.) that can be operated by the user U, and sensors that detect and output the operations (the operation amount, the operation direction, etc.) of the operating elements. The operation detection unit 20 outputs information indicating the operations of the operating elements (referred to as operation information) to the computation unit 24.

The communication unit 22 may be constituted by, for example, a wireless communication module (an integrated circuit module) including an antenna and the like. The communication unit 22 may transmit a signal to the outside of the controller 12.

The computation unit 24 may be constituted by a processor such as a central processing unit (CPU) or a graphics processing unit (GPU). That is, the computation unit 24 may be constituted by a processing circuitry. At least part of the computation unit 24 may be realized by an integrated circuit such as an application specific integrated circuit (ASIC) or a field-programmable gate array (FPGA). At least part of the computation unit 24 may be realized by an electronic circuit including a discrete device.

The computation unit 24 includes an acquisition unit 28 and a communication control unit 30. The acquisition unit 28 and the communication control unit 30 can be realized by programs stored in the storage unit 26 being executed by the computation unit 24. The acquisition unit 28 acquires a signal transmitted from the outside of the computation unit 24. The communication control unit 30 performs processing for transmitting a signal to the outside of the controller 12 via the communication unit 22.

The storage unit 26 is a computer-readable storage medium. The storage unit 26 is constituted by a volatile memory (not shown) and a non-volatile memory (not shown). The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored in, for example, the non-volatile memory. At least part of the storage unit 26 may be included in the processor, the integrated circuit, or the like described above.

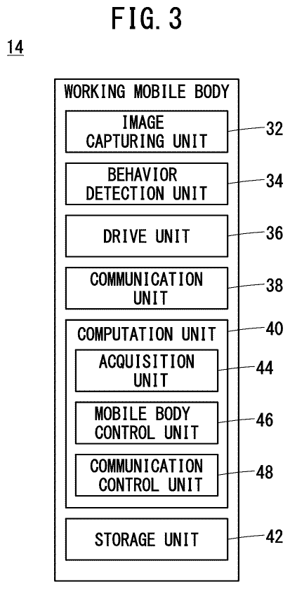

FIG. 3 is a functional block diagram of the working mobile body 14 according to the first embodiment. The working mobile body 14 is a mobile body that performs a predetermined work while propelling itself. For example, the working mobile body 14 may be a self-propelled vacuum cleaner, a self-propelled lawn mower, or the like. The working mobile body 14 includes an image capturing unit 32, a behavior detection unit 34, a drive unit 36, a communication unit 38, a computation unit 40, and a storage unit 42.

The image capturing unit 32 can be constituted by a camera. The image capturing unit 32 captures an image of the periphery surrounding the working mobile body 14 to acquire an image of the real space (referred to as a real space image). The image capturing unit 32 outputs the real space image to the computation unit 40.

The behavior detection unit 34 is constituted by, for example, an encoder, an acceleration sensor, a gyro sensor, or the like. The behavior detection unit 34 detects a behavior of the working mobile body 14 related to its traveling. The behavior detection unit 34 outputs the detected information (referred to as behavior information) to the computation unit 40.

The drive unit 36 may be constituted by, for example, a battery, an electric power supply circuit, an electric motor, a power transmission mechanism, and left and right wheels. The electric power supply circuit supplies power from the battery to the electric motor. The power transmission mechanism transmits motive power from the electric motor to the left and right wheels.

The communication unit 38 may be constituted by, for example, a wireless communication module including an antenna and the like. The communication unit 38 may transmit a signal to the outside of the working mobile body 14. Also, the communication unit 38 may receive a signal from the outside of the working mobile body 14.

The computation unit 40 may be constituted by a processor such as a CPU, a GPU, or the like. More specifically, the computation unit 40 may be configured by a processing circuitry. Moreover, at least a portion of the computation unit 40 may be realized by an integrated circuit such as an ASIC, an FPGA, or the like. At least part of the computation unit 40 may be realized by an electronic circuit including a discrete device.

The computation unit 40 includes an acquisition unit 44, a mobile body control unit 46, and a communication control unit 48. The acquisition unit 44, the mobile body control unit 46, and the communication control unit 48 can be realized by programs stored in the storage unit 42 being executed by the computation unit 40. The acquisition unit 44 acquires a signal transmitted from the outside of the computation unit 40. The mobile body control unit 46 controls the operation or behavior of the working mobile body 14 related to its movement. The communication control unit 48 performs processing for transmitting a signal to the outside of the working mobile body 14 via the communication unit 38.

The storage unit 42 is a computer-readable storage medium. The storage unit 42 is constituted by a volatile memory (not shown) and a non-volatile memory (not shown). The volatile memory is, for example, a RAM or the like. The non-volatile memory is, for example, a ROM, a flash memory, or the like. Data and the like are stored in, for example, the volatile memory. Programs, tables, maps, and the like are stored, for example, in the non-volatile memory. At least part of the storage unit 42 may be included in the processor, the integrated circuit, or the like described above.

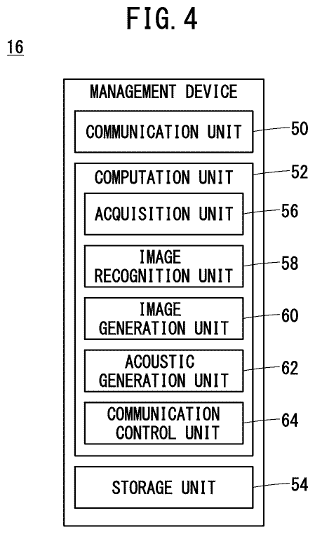

FIG. 4 is a functional block diagram of the management device 16 according to the first embodiment. The management device 16 is a device for generating a virtual space image corresponding to the real space. For example, the management device 16 may be a computer. The management device 16 includes a communication unit 50, a computation unit 52, and a storage unit 54.

The communication unit 50 may be constituted by, for example, a wireless communication module including an antenna and the like. The communication unit 50 may transmit a signal to the outside of the management device 16. Also, the communication unit 50 may receive a signal from the outside of the management device 16.

The computation unit 52 may be constituted by a processor such as a CPU, a GPU, or the like. More specifically, the computation unit 52 may be configured by a processing circuitry. Moreover, at least a portion of the computation unit 52 may be realized by an integrated circuit such as an ASIC, an FPGA, or the like. At least part of the computation unit 52 may be realized by an electronic circuit including a discrete device.

The computation unit 52 includes an acquisition unit (data acquisition unit) 56, an image recognition unit 58, an image generation unit 60, an acoustic generation unit 62, and a communication control unit 64. The acquisition unit 56, the image recognition unit 58, the image generation unit 60, the acoustic generation unit 62, and the communication control unit 64 can be realized by programs stored in the storage unit 54 being executed by the computation unit 52. The acquisition unit 56 acquires a signal transmitted from the outside of the computation unit 52. The image recognition unit 58 recognizes the real space by performing image recognition. The image generation unit 60 generates a virtual space image corresponding to the real space, and generates an image signal indicating the virtual space image. The acoustic generation unit 62 generates a sound effect and generates an acoustic signal indicating the sound effect. The communication control unit 64 performs processing for transmitting a signal to the outside of the management device 16 via the communication unit 50.

The storage unit 54 is a computer-readable storage medium. The storage unit 54 is constituted by a volatile memory (not shown) and a non-volatile memory (not shown). The volatile memory is, for example, a RAM or the like. The non-volatile memory is, for example, a ROM, a flash memory, or the like. Data and the like are stored in, for example, the volatile memory. Programs, tables, maps, and the like are stored, for example, in the non-volatile memory. At least part of the storage unit 54 may be included in the processor, the integrated circuit, or the like described above.

The storage unit 54 stores in advance the image data of the virtual space image generated by the image generation unit 60. The storage unit 54 stores in advance the acoustic data of the sound effect generated by the acoustic generation unit 62.

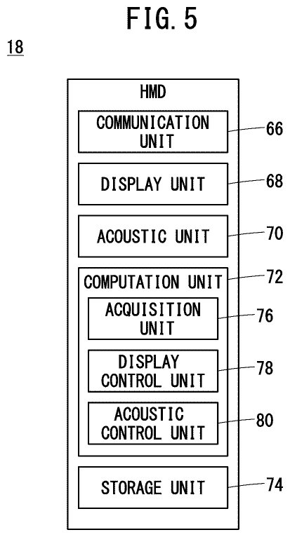

FIG. 5 is a functional block diagram of the head-mounted display 18 according to the first embodiment. In the present specification, the head-mounted display 18 is also referred to as an HMD 18. The user U wears the HMD 18 on the head. The HMD 18 includes a communication unit 66, a display unit 68, an acoustic unit (acoustic output unit) 70, a computation unit 72, and a storage unit 74.

The communication unit 66 may be constituted by, for example, a wireless communication module including an antenna and the like. The communication unit 66 may transmit a signal to the outside of the HMD 18. The communication unit 66 can receive a signal from the outside of the HMD 18.

The display unit 68 may be constituted by, for example, a display device. The screen of the display device is close to both eyes of the user U. The display unit 68 displays (projects) a virtual space image on a display surface based on the image signal transmitted from the computation unit 72. The display unit 68 may provide the virtual space image to the user U.

The acoustic unit 70 may be constituted by, for example, an audio device. The speaker (including a headphone and an earphone) of the acoustic unit 70 is close to the ear of the user U. The acoustic unit 70 outputs a sound effect (sound) from a speaker based on the acoustic signal transmitted from the computation unit 72. The acoustic unit 70 may provide sound effects to the user U.

The computation unit 72 may be constituted by a processor such as a CPU, a GPU, or the like. More specifically, the computation unit 72 may be configured by a processing circuitry. Moreover, at least a portion of the computation unit 72 may be realized by an integrated circuit such as an ASIC, an FPGA, or the like. At least part of the computation unit 72 may be realized by an electronic circuit including a discrete device.

The computation unit 72 includes an acquisition unit 76, a display control unit 78, and an acoustic control unit 80. The acquisition unit 76, the display control unit 78, and the acoustic control unit 80 can be realized by programs stored in the storage unit 74 being executed by the computation unit 72. The acquisition unit 76 acquires a signal transmitted from the outside of the computation unit 72. The display control unit 78 causes the display unit 68 to display the virtual space image. The acoustic control unit 80 causes the acoustic unit 70 to output the sound effects.

The storage unit 74 is a computer-readable storage medium. The storage unit 74 is constituted by a volatile memory (not shown) and a non-volatile memory (not shown). The volatile memory is, for example, a RAM or the like. The non-volatile memory is, for example, a ROM, a flash memory, or the like. Data and the like are stored in, for example, the volatile memory. Programs, tables, maps, and the like are stored, for example, in the non-volatile memory. At least part of the storage unit 74 may be included in the processor, the integrated circuit, or the like described above.

### 1-2 Functions of Working System 10

In the working system 10, the operation of the working mobile body 14 by the user U and provision of the virtual space image to the user U are performed.

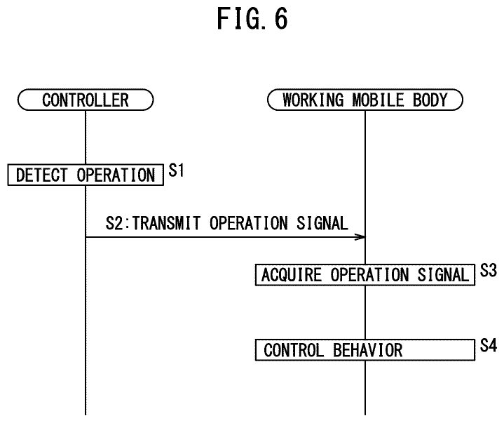

FIG. 6 is a sequence diagram relating to the operation of the working mobile body 14. When the user U operates the operating element of the controller 12, the working mobile body 14 operates or behaves in accordance with the operation of the user U.

In step S1, the operation detection unit 20 of the controller 12 detects an operation of the operating element by the user U. The acquisition unit 28 of the controller 12 acquires the operation information from the operation detection unit 20.

In step S2, the communication control unit 30 of the controller 12 performs processing for generating an operation signal corresponding to the operation information and transmitting the generated operation signal. The communication unit 22 of the controller 12 transmits the operation signal to the working mobile body 14 in accordance with the processing performed by the communication control unit 30.

In step S3, the communication unit 38 of the working mobile body 14 receives the operation signal. The acquisition unit 44 of the working mobile body 14 acquires the operation signal via the communication unit 38.

In step S4, the mobile body control unit 46 of the working mobile body 14 controls the operation or behavior of the working mobile body 14 in accordance with the operation signal acquired by the acquisition unit 44. For example, the mobile body control unit 46 controls the operation of an electric motor provided in the drive unit 36.

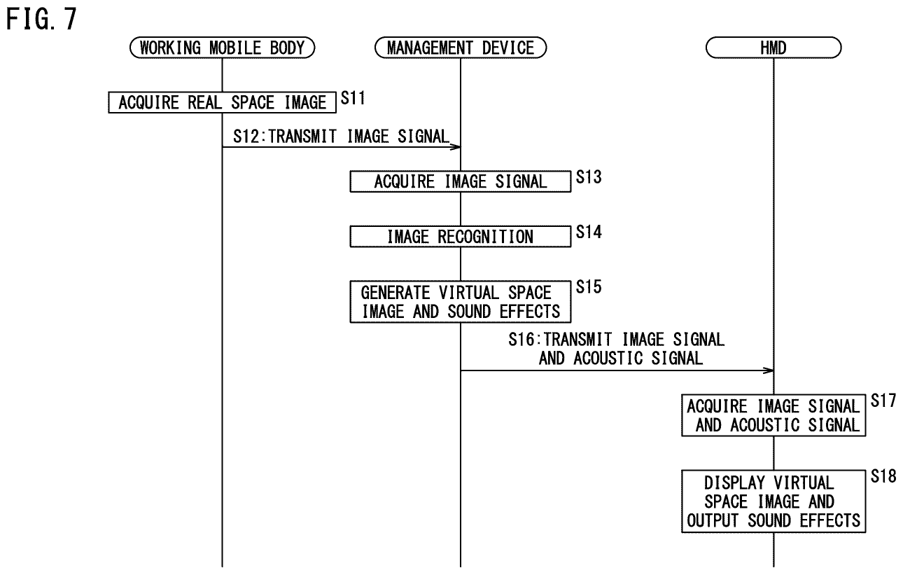

FIG. 7 is a sequence diagram relating to the display of a virtual space image. During working by the working mobile body 14, the user U is provided with a virtual space image and sound effects by the HMD 18.

In step S11, the image capturing unit 32 of the working mobile body 14 captures an image of the periphery surrounding the working mobile body 14 at all times or at regular intervals. The acquisition unit 44 of the working mobile body 14 acquires a real space image from the image capturing unit 32.

In step S12, the communication control unit 48 of the working mobile body 14 performs processing of generating an image signal corresponding to the real space image and transmitting the generated image signal. The communication unit 38 of the working mobile body 14 transmits the image signal to the management device 16 in accordance with the processing performed by the communication control unit 48.

In step S13, the communication unit 50 of the management device 16 receives the image signal. The acquisition unit 56 of the management device 16 acquires the image signal via the communication unit 50.

In step S14, the image recognition unit 58 of the management device 16 performs image recognition of the real space image indicated by the image signal. Furthermore, the image recognition unit 58 determines whether or not a specific space or a specific object exists around the working mobile body 14. Information for recognizing a specific space and a specific object is set in advance in the storage unit 54.

In step S15, the image generation unit 60 of the management device 16 generates a virtual space image corresponding to the real space image. For example, the image generation unit 60 generates the virtual space image by superimposing images of predetermined characters (an animal, a dinosaur, and the like) on the real space image. The image generation unit 60 may superimpose an image of a predetermined character on a specific space or a specific object recognized by the image recognition unit 58, or may superimpose an image of a predetermined character on an arbitrary position of the real space image. The image generation unit 60 may superimpose an image other than the character, for example, an image of a desert, on the floor surface of the real space image. The image data of the predetermined character is stored in the storage unit 54. The image generation unit 60 may generate a virtual space image corresponding to the real space image by computer graphics or the like. The image generation unit 60 may generate other image (virtual space image) data by using real space image data. In step S15, the acoustic generation unit 62 of the management device 16 generates sound effects. The data of the sound effects is stored in the storage unit 54. The acoustic generation unit 62 may generate other data of sound effects by using existing data of sound effects.

In step S16, the communication control unit 64 of the management device 16 performs processing for generating an image signal corresponding to the virtual space image and an acoustic signal corresponding to the sound effects and transmitting the generated image signal and acoustic signal. The communication unit 50 of the management device 16 transmits the image signal and the acoustic signal to the HMD 18 in accordance with the processing performed by the communication control unit 64.

In step S17, the communication unit 66 of the HMD 18 receives the image signal and the acoustic signal. The acquisition unit 76 of the HMD 18 acquires the image signal and the acoustic signal via the communication unit 66.

In step S18, the display control unit 78 of the HMD 18 causes the display unit 68 to display the virtual space image in accordance with the image signal acquired by the acquisition unit 76. The acoustic control unit 80 of the HMD 18 causes the acoustic unit 70 to output sound effects in accordance with the acoustic signal acquired by the acquisition unit 76.

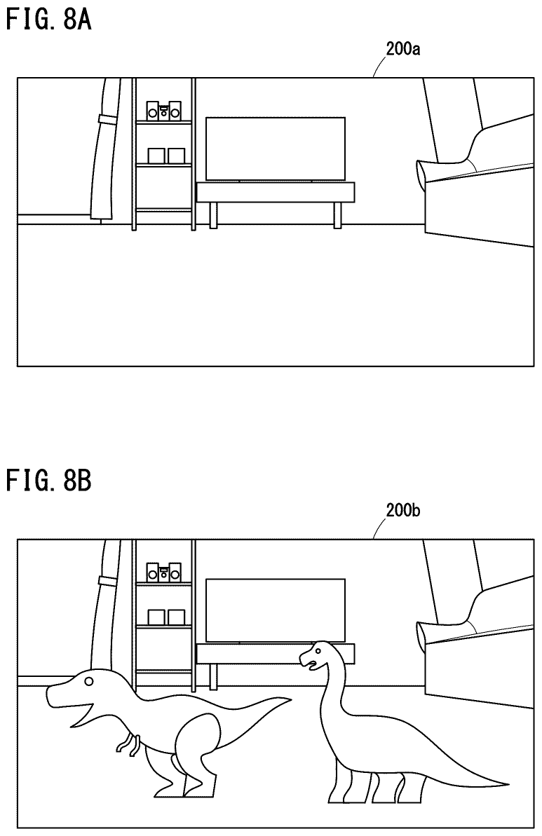

FIG. 8A is a diagram illustrating a real space image. FIG. 8B is a diagram illustrating a virtual space image. According to the present embodiment, the image capturing unit 32 of the working mobile body 14 acquires an image (corresponding to a real space image) 200a as shown in FIG. 8A. The management device 16 generates an image (corresponding to a virtual space image) 200b as shown in FIG. 8B based on the image 200a. The display unit 68 of the HMD 18 displays the image 200b. Thus, the user U wearing the HMD 18 can experience the feeling of working in a virtual space where various characters exist.

### 1-3 Modifications

The operation signal generated by the controller 12 may be transmitted to the working mobile body 14 via the management device 16. The controller 12, the working mobile body 14, the management device 16, and the head-mounted display 18 may communicate with each other via a communication line such as the Internet.

When the image generation unit 60 of the management device 16 generates the entire virtual space image based on the image data generated by computer graphics or the like, the real space image may not be acquired. In this case, the image generation unit 60 needs to grasp the position and the direction of the working mobile body 14 all the time. For example, the image generation unit 60 grasps the position and the direction of the working mobile body 14 in the following manner.

The storage unit 54 of the management device 16 stores in advance a map of work target area, positions of objects existing in the work target area, the shapes of the objects, and the like. The map of the work target area includes information of a coordinate system having a reference position as the origin. The reference position is a position (such as a position of a charger) at which the working mobile body 14 starts to move, and is predetermined. The moving body control unit 46 can estimate the position and the direction of the working mobile body 14 in the work target area, based on a behavior signal transmitted from the working mobile body 14 and the map of the work target area stored in the storage unit 54. The image generation unit 60 generates a virtual space image corresponding to the position and the direction of the working mobile body 14 estimated by the mobile body control unit 46 by computer graphics or the like.

### 1-4 Advantageous Effects of First Embodiment

According to the first embodiment, the user U can perform work in the real space while experiencing the virtual space. Therefore, the user U can enjoy the work in which the working mobile body 14 is used. As a result, the user U actively performs the work using the working mobile body 14, and the work is promoted. Thus, according to the present embodiment, a satisfactory working system 10 can be provided.

Various functions can be added to the first embodiment and the modification thereof. Functions that can be added to the first embodiment and its modifications will be described in second embodiment to eighth embodiment.

### 2 Second Embodiment

The image generation unit 60 of the management device 16 may generate a virtual space image in which the visual attraction of the work target area is enhanced according to the work priority level. Specific examples thereof will be described below.

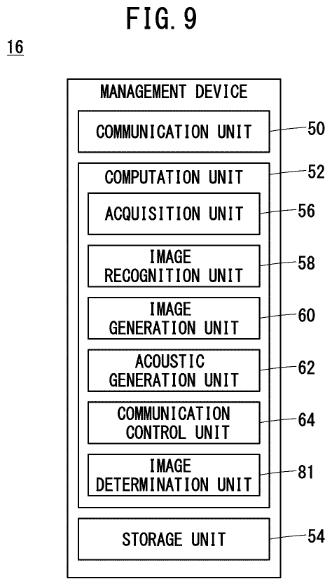

FIG. 9 is a functional block diagram of the management device 16 according to the second embodiment. In the second embodiment, the same constituent elements as those in the first embodiment are denoted by the same reference numerals, and the description thereof is omitted.

The computation unit 52 of the management device 16 includes an image determination unit 81. The image determination unit 81 can be realized by programs stored in the storage unit 54 being executed by the computation unit 52.

The image determination unit 81 determines whether or not there is an area in a predetermined state in the real space, based on the recognition result of the real space image by the image recognition unit 58. In the case where the working mobile body 14 is a vacuum cleaner, the area in the predetermined state may be an area where the amount of dust is larger than a predetermined value. In the case where the working mobile body 14 is a lawn mower, the area in the predetermined state may be an area where the length of the lawn is longer than a predetermined value.

For example, the image determination unit 81 determines a work priority level of the area in the predetermined state to be high, and determines a work priority level of the area other than the area in the predetermined state to be low. The image generation unit 60 generates a virtual space image based on the result of the determination by the image determination unit 81. The image generation unit 60 may enhance the visual attractiveness of the area in the predetermined state by changing the display color of the area in the predetermined state to a color that is more visually-attractive than the display color of other areas in the virtual space image. Alternatively, the image generation unit 60 may enhance the visual attractiveness of the area in the predetermined state by superimposing a display object having high visual attractiveness on the area in the predetermined state in the virtual space image.

The image determination unit 81 may determine the work priority level of a specific area (such as a corner of a work target area) to be high and the work priority level of an area other than the specific area to be low.

According to the second embodiment, by enhancing the visual attractiveness of the area with a high work priority level, the user U can be prompted to move the working mobile body 14 to the area with a high work priority level. This makes it possible to perform work in an area with the high work priority level.

### 3 Third Embodiment

The image generation unit 60 of the management device 16 may change the virtual space image according to the working conditions of the working mobile body 14. Similarly, the acoustic generation unit 62 of the management device 16 may change the sound effects in accordance with the working conditions of the working mobile body 14.

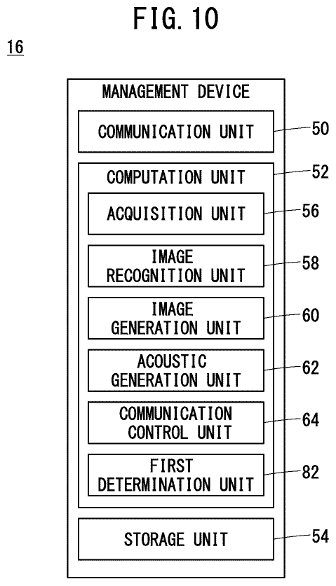

FIG. 10 is a functional block diagram of the management device 16 according to the third embodiment. In the third embodiment, the same constituent elements as those in the first embodiment are denoted by the same reference numerals, and the description thereof is omitted.

The computation unit 52 of the management device 16 includes a first determination unit (determination unit) 82. The first determination unit 82 can be realized by programs stored in the storage unit 54 being executed by the computation unit 52.

The first determination unit 82 determines the working conditions of the working mobile body 14. For example, the first determination unit 82 determines the moving speed of the working mobile body 14 as the working condition of the working mobile body 14. In this case, the first determination unit 82 determines the moving speed of the working mobile body 14 based on the behavior signal acquired by the acquisition unit 56. Further, the first determination unit 82 compares the moving speed of the working mobile body 14 with a speed threshold value stored in advance in the storage unit 54. In the case that the moving speed is equal to or higher than the speed threshold value, the first determination unit 82 determines that the working mobile body 14 is moving at a high speed and the working condition is good. On the other hand, in the case that the moving speed is less than the speed threshold value, the first determination unit 82 determines that the working mobile body 14 is moving at a low speed and the working condition is poor (the work is slow).

In the case that the first determination unit 82 determines that the working condition of the working mobile body 14 is poor (the work is slow), the image generation unit 60 generates a virtual space image for prompting the user U to work. For example, the image generation unit 60 generates a virtual space image including an image of a character that prompts the user to work. The image generation unit 60 may change the display color of the virtual space image to a display color different from the normal display color. The image generation unit 60 may generate a virtual space image including a message.

In the case that the first determination unit 82 determines that the working condition of the working mobile body 14 is poor (the work is slow), the acoustic generation unit 62 generates a sound effect for prompting the user U to work. For example, the acoustic generation unit 62 sets music as a sound effect for prompting the user to work, to up-tempo.

According to the third embodiment, it is possible to prompt the user U to work quickly. Consequently, the working speed when the working mobile body 14 is used can be increased.

### 4 Fourth Embodiment

The image generation unit 60 of the management device 16 may be capable of generating a plurality of types of virtual space images having different viewpoints. For example, the image generation unit 60 may be capable of generating a first virtual space image that is a virtual space image corresponding to a case where a viewpoint is placed on the working mobile body 14 and a second virtual space image that is a virtual space image corresponding to a case where a viewpoint is placed outside the working mobile body 14.

The image generation unit 60 generates the first virtual space image by the method described in the first embodiment. The image generation unit 60 generates the second virtual space image of the work target area as viewed from above the work target area by computer graphics or the like. In the case that the work target area is provided with an overhead view camera (not shown) for overhead viewing of the work target area, the image generation unit 60 may generate a second virtual space image corresponding to the real space image acquired by the overhead view camera.

Furthermore, in the case of generating the second virtual space image, the image generation unit 60 may set a virtual object corresponding to the working mobile body 14, to the working mobile body 14 in the second virtual space image. For example, the image generation unit 60 may superimpose an animal, a car, or the like on the working mobile body 14 in the second virtual space image.

The virtual space image displayed on the HMD 18 may be switchable in accordance with an operation of the user U. In this case, each of a first image signal representing the first virtual space image and a second image signal representing the second virtual space image is transmitted from the management device 16 to the HMD 18. When the user U operates a switch (not shown) of the HMD 18, the display control unit 78 selectively displays either the first virtual space image or the second virtual space image on the display unit 68.

According to the fourth embodiment, the user U can operate the virtual object while viewing the virtual object in the virtual space. Consequently, the user U can enjoy more the work in which the working mobile body 14 is used.

### 5 Fifth Embodiment

The image generation unit 60 of the management device 16 may change the virtual space image in accordance with a working history of the user U. Similarly, the acoustic generation unit 62 of the management device 16 may change the sound effects in accordance with the working history of the user U.

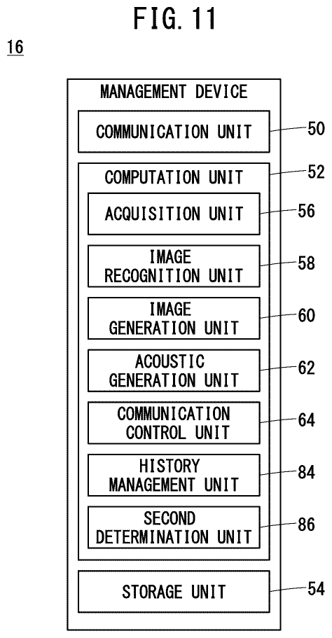

FIG. 11 is a functional block diagram of the management device 16 according to the fifth embodiment. In the fifth embodiment, the same constituent elements as those in the first embodiment are denoted by the same reference numerals, and the description thereof is omitted.

The computation unit 52 of the management device 16 includes a history management unit 84 and a second determination unit 86. The history management unit 84 and the second determination unit 86 can be realized by programs stored in the storage unit 54 being executed by the computation unit 52.

The history management unit 84 manages the working history of the user U. The working history may be a total time obtained by adding up the periods of time when the user U operated the working mobile body 14. The working history may be a total distance obtained by adding up the distances by which the user U has moved the working mobile body 14. The working history may be a working characteristic of the user U. The working history may be an operation characteristic of the user U. The storage unit 54 stores information of the working history for each of the users U.

In the case that the working history is the total time, the history management unit 84 counts the time during which the working mobile body 14 is in operation. The time during which the working mobile body 14 is in operation (the operating time of the working mobile body 14) corresponds to the time during which the user U operates the working mobile body 14. The history management unit 84 adds the counted time to the total time stored in the storage unit 54 at the end of the work of the working mobile body 14. Thus, the operating time of the working mobile body 14 is accumulated in the total time in the storage unit 54. The total time corresponds to the experience value of the user U. The total time is a guide to judge the technical level of the user U.

When the working history is the total distance, the history management unit 84 counts the distance the working mobile body 14 has moved based on the detection result of the behavior detection unit 34 of the working mobile body 14. The distance the working mobile body 14 has moved (the movement distance of the working mobile body 14) corresponds to the distance the user U has caused the working mobile body 14 to move. The history management unit 84 adds the counted distance to the total distance stored in the storage unit 54 at the end of the work of the working mobile body 14. Thus, the movement distance of the working mobile body 14 is accumulated in the total distance of the storage unit 54. The total distance corresponds to the experience value of the user U. The total distance is a guide to judge the technical level of the user U.

When the working history is the working characteristic of the user U, the history management unit 84 stores in the storage unit 54 the working mode set in the working mobile body 14 every time the work is performed, for example. The working mode includes a mode for beginners of work, a mode for advanced workers of work, and the like. The user U sets the working mode of the working mobile body 14 in accordance with the skill level of the user U. The working characteristic is a guide to judge the technical level of the user U.

When the working history is the operation characteristic of the user U, the history management unit 84 monitors the movement trajectory of the working mobile body 14 every time the work is performed, for example. The history management unit 84 stores the areas moved two or more times in the storage unit 54. That is, the history management unit 84 stores the area where the work is repeated (referred to as a repetition area) in the storage unit 54. The user U with a high technical level has a small number of repetition areas in one work. The user U with a low technical level has a large number of repetition areas in one operation. That is, the operation characteristic is a guide to judge the technical level of the user U.

The second determination unit 86 determines the technical level of the user U based on the working history. For example, the second determination unit 86 determines that the user U is an advanced user in the case that the total time stored in the storage unit 54 is longer than a predetermined period of time. For example, the second determination unit 86 determines that the user U is an advanced user in the case that the total distance stored in the storage unit 54 is longer than a predetermined distance. For example, the second determination unit 86 determines that the user U is an advanced user in the case that the most recent working mode stored in the storage unit 54 is a mode for an advanced user. For example, the second determination unit 86 determines that the user U is an advanced user in the case that the amount of the repetition area stored in the storage unit 54 is smaller than a predetermined amount.

In the case that the second determination unit 86 determines that the user U is an advanced user, the image generation unit 60 generates a virtual space image for an advanced user. On the other hand, in the case that the second determination unit 86 determines that the user U is not an advanced user, the image generation unit 60 generates a normal virtual space image.

In the case that the second determination unit 86 determines that the user U is an advanced user, the acoustic generation unit 62 generates a sound effect for an advanced user. On the other hand, in the case that the second determination unit 86 determines that the user U is not an advanced user, the acoustic generation unit 62 generates a normal sound effect.

According to the fifth embodiment, since the virtual space image and the sound effect change according to the technical level of the user U, it is possible to provide the user U with motivation for improving the technical level.

### 6 Sixth Embodiment

In order to enhance the playability of the working system 10, points may be given to the user U.

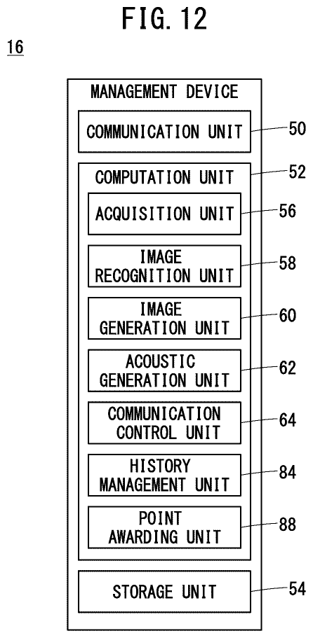

FIG. 12 is a functional block diagram of the management device 16 according to the sixth embodiment. In the sixth embodiment, the same constituent elements as those in the fifth embodiment are denoted by the same reference numerals, and the description thereof is omitted.

A computation unit 52 of the management device 16 includes a history management unit 84 and a point awarding unit 88. The history management unit 84 and the point awarding unit 88 can be realized by programs stored in the storage unit 54 being executed by the computation unit 52.

As described in the fifth embodiment, the history management unit 84 manages the working history of the user U. The working history may be a total time obtained by adding up the periods of time when the user U operated the working mobile body 14. The working history may be a total distance obtained by adding up the distances the user U has moved the working mobile body 14. The history management unit 84 stores the total time and the total distance in the storage unit 54.

The point awarding unit 88 awards the user U points in accordance with the total time or the total distance stored in the storage unit 54. For example, the point awarding unit 88 awards a predetermined amount of points each time the total time increases by a predetermined period of time. Alternatively, the point awarding unit 88 awards a predetermined amount of points each time the total distance increases by a predetermined distance. The point awarding unit 88 stores the total value of the points in the storage unit 54.

According to the sixth embodiment, since points are awarded to the user U according to the work (total time or total distance), an incentive for the user U to perform the work can be given.

### 7 Seventh Embodiment

The working mobile body 14 may have a function of avoiding contact with an obstacle. For example, the mobile body control unit 46 of the working mobile body 14 may control the working mobile body 14 so as to avoid contact between the working mobile body 14 and an obstacle.

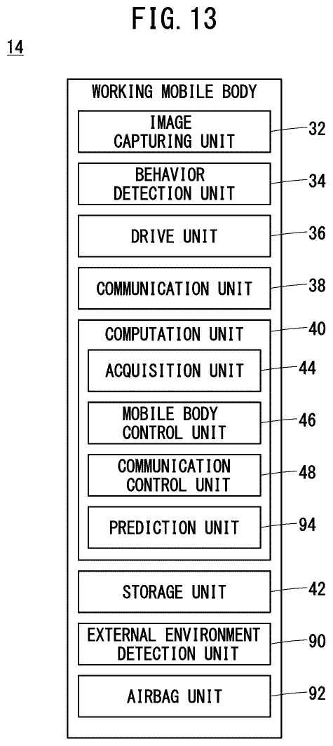

FIG. 13 is a functional block diagram of a working mobile body 14 according to a seventh embodiment. In the seventh embodiment, the same components as those in the first embodiment are denoted by the same reference numerals, and the description thereof will be omitted. The working mobile body 14 is provided with an external environment detection unit 90 and an airbag unit 92.

The external environment detection unit 90 may be configured by an external environment sensor such as a radar or a LiDAR. The external environment detection unit 90 detects the distance from the working mobile body 14 to a surrounding object (an obstacle or the like). The external environment detection unit 90 outputs the detected information (referred to as external environment information) to the computation unit 40.

The airbag unit 92 can be configured by an airbag module. An airbag module is provided with an airbag, an inflator for supplying gas to the airbag, and a drive circuit for driving the inflator. For example, one airbag is disposed on each of the front, rear, left and right sides of the working mobile body 14.

The computation unit 40 includes a prediction unit 94. The prediction unit 94 can be realized by programs stored in the storage unit 42 being executed by the computation unit 40.

The prediction unit 94 predicts whether or not the working mobile body 14 will contact an obstacle. For example, the prediction unit 94 calculates a time to collision (TTC) until the working mobile body 14 and the obstacle come into contact with each other based on the behavior information and the external environment information. The prediction unit 94 predicts that the working mobile body 14 and the obstacle will come into contact with each other when the TTC is less than a predetermined first time threshold value. Furthermore, when the TTC is less than a predetermined second time threshold value (first time threshold value), the prediction unit 94 determines that the contact between the working mobile body 14 and the obstacle is unavoidable.

In the case that the prediction unit 94 predicts that the working mobile body 14 will come into contact with the obstacle, the mobile body control unit 46 controls the working mobile body 14 so as to avoid the contact between the working mobile body 14 and the obstacle. For example, the mobile body control unit 46 may change the direction of movement of the working mobile body 14 or may stop the working mobile body 14.

In the case that the prediction unit 94 determines that the contact between the working mobile body 14 and the obstacle is unavoidable, the mobile body control unit 46 outputs a drive signal to the airbag unit 92. The airbag unit 92 deploys the airbag in response to the drive signal.

According to the seventh embodiment, the working mobile body 14 can be prevented from being damaged. Therefore, the user U can operate the working mobile body 14 with confidence.

### 8 Eighth Embodiment

The image data and the acoustic data stored in the storage unit 54 of the management device 16 may be acquired via network communications.

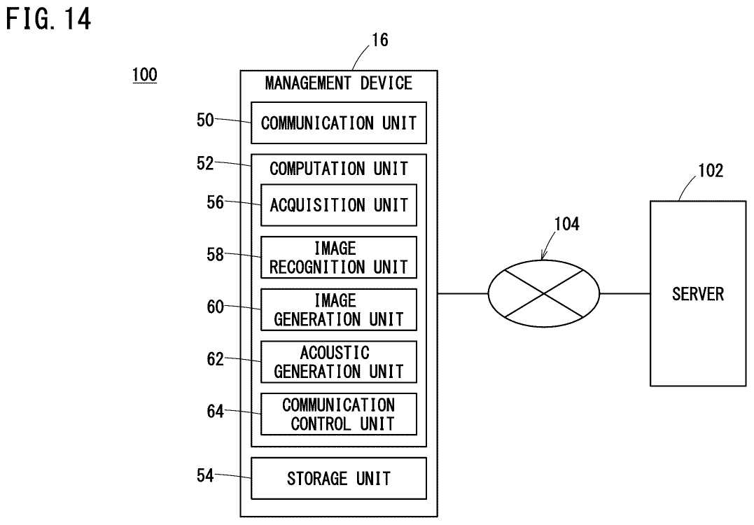

FIG. 14 is a schematic configuration diagram of a communication system 100 according to an eighth embodiment. In the eighth embodiment, the same components as those of the first embodiment are denoted by the same reference numerals, and the description thereof will be omitted.

The communication system 100 includes the management device 16 of the working system 10, a server 102, and a communication line 104 such as the Internet. The management device 16 and the server 102 are connected to each other through the communication line 104 so as to be capable of two-way communication. The server 102 may transmit the image data of the virtual space image and the acoustic data of the sound effect to the management device 16 via the communication line 104.

In the management device 16, the acquisition unit 56 of the computation unit 52 may acquire the image data and the acoustic data from the server 102 via the communication line 104. The acquisition unit 56 stores the acquired image data and acoustic data in the storage unit 54. The image data and the acoustic data stored in the storage unit 54 may be updated or newly added.

According to the eighth embodiment, the user U can experience the latest virtual space and the latest sound effect.

### 9 Other Considerations

A plurality of embodiments among the second embodiment to the eighth embodiment may be combined.

In each of the embodiments, the working system 10 may not include the management device 16. In this case, the respective functions of the computation unit 52 of the management device 16 are provided in the computation unit 40 of the working mobile body 14 or the computation unit 72 of the HMD 18.

### 10 Supplementary Notes

The following supplementary notes are further disclosed in relation to the above-described embodiments.

### Supplementary Note 1

The working system (10) according to the present disclosure is configured to perform the work by the working mobile body (14) remotely operated by the user (U), and includes the image generation unit (60) configured to generate the virtual space image (200b) corresponding to the real space around the working mobile body, and the head-mounted display (18) configured to be worn by the user and provide the user with the virtual space image generated by the image generation unit, wherein the image generation unit generates the virtual space image corresponding to the position and the direction of the working mobile body.

In accordance with the configuration of Supplementary Note 1, the user can perform the work in the real space while experiencing the virtual space. Therefore, the user can enjoy the work in which the working mobile body is used. As a result, the user actively performs the work using the working mobile body, and the work is promoted. That is, in accordance with the configuration of Supplementary Note 1, it is possible to provide a satisfactory working system.

### Supplementary Note 2

In the working system according to Supplementary Note 1, the image generation unit may generate the virtual space image in which the visual attraction of the work target area is enhanced in accordance with the work priority level.

In accordance with the configuration of Supplementary Note 2, by enhancing the visual attraction of the area with a high work priority level, the user can be prompted to move the working mobile body to the area with the high work priority level. This makes it possible to perform work in an area with the high work priority level.

### Supplementary Note 3

The working system according to Supplementary Note 1 may further include the determination unit (82) configured to determine the working condition of the working mobile body, wherein the image generation unit may change the virtual space image in accordance with the working condition determined by the determination unit.

### Supplementary Note 4

The working system according to Supplementary Note 3 may further include the acoustic generation unit (62) configured to generate the acoustic signal, and the acoustic output unit (70) configured to provide the user with the sound corresponding to the acoustic signal generated by the acoustic generation unit, wherein the acoustic generation unit may change the acoustic signal in accordance with the working condition determined by the determination unit.

In accordance with the configuration of Supplementary Note 3 and the configuration of Supplementary Note 4, it is possible to prompt the user to work quickly. Consequently, the working speed when the working mobile body is used can be increased.

### Supplementary Note 5

In the working system according to Supplementary Note 1, the image generation unit may generate the first virtual space image and the second virtual space image, the first virtual space image being the virtual space image corresponding to the case where the viewpoint is placed on the working mobile body, the second virtual space image being the virtual space image corresponding to the case where the viewpoint is placed outside the working mobile body, and in the case of generating the second virtual space image, the image generation unit may set the virtual object corresponding to the working mobile body, for the working mobile body in the second virtual space image.

In accordance with the configuration of Supplementary Note 5, the user can operate the virtual object while viewing the virtual object in the virtual space. Consequently, the user can enjoy more the work in which the working mobile body is used.

### Supplementary Note 6

In the working system according to Supplementary Note 1, the image generation unit may change the virtual space image in accordance with at least one of the total time obtained by adding up periods of time when the user operates the working mobile body, the total distance obtained by adding up distances that the user moves the working mobile body, the working characteristic of the user, or the operation characteristic of the user.

### Supplementary Note 7

The working system according to Supplementary Note 1 may further include the acoustic generation unit configured to generate the acoustic signal, and the acoustic output unit configured to provide the sound corresponding to the acoustic signal generated by the acoustic generation unit to the user, wherein the acoustic generation unit may change the acoustic signal, in accordance with at least one of the total time obtained by adding up periods of time when the user operates the working mobile body, the total distance obtained by adding up distances that the user moves the working mobile body, the working characteristic of the user, or the operation characteristic of the user.

In accordance with the configuration of Supplementary Note 6 and the configuration of Supplementary Note 7, since the virtual space image and the sound effect change according to the technical level of the user, it is possible to provide the user with motivation for improving the technical level.

### Supplementary Note 8

The working system according to Supplementary Note 1 may further include the point awarding unit (88) configured to award the user the point in accordance with the work performed by the working mobile body remotely operated by the user.

In accordance with the configuration of Supplementary Note 8, since the point is awarded to the user in accordance with the work, an incentive for the user to perform the work can be given.

### Supplementary Note 9

The working system according to Supplementary Note 1 may further include the prediction unit (94) configured to predict whether or not the working mobile body contacts an obstacle, and the mobile body control unit (46) configured to control the working mobile body so as to avoid the contact between the working mobile body and the obstacle in the case that the contact between the working mobile body and the obstacle is predicted by the prediction unit.

### Supplementary Note 10

In the working system according to Supplementary Note 9, the moving body control unit may deploy the airbag provided in the working mobile body in the case that the contact between the working mobile body and the obstacle is unavoidable.

In accordance with the configuration of Supplementary Note 9 and the configuration of Supplementary Note 10, the working mobile body can be prevented from being damaged. Therefore, the user U can operate the working mobile body with confidence.

### Supplementary Note 11

The working system according to Supplementary Note 1 may further include the data acquisition unit (56) configured to acquire the image data configured to be used in generating the virtual space image through the network communication, wherein the image generation unit may generate the virtual space image using the image data acquired by the data acquisition unit.

### Supplementary Note 12

The working system according to Supplementary Note 4 or 7 may further include the data acquisition unit configured to acquire the acoustic data configured to be used in generating the acoustic signal through the network communication, wherein the acoustic generation unit may generate the acoustic signal using the acoustic data acquired by the data acquisition unit.

According to the configuration of Supplementary Note 11 and the configuration of Supplementary Note 12, the user can experience the latest virtual space and the latest sound effect.

While the present disclosure has been described in detail, the present disclosure is not limited to the individual embodiments described above. Within a range that does not depart from the essence and gist of the present disclosure, or within a range that does not depart from the gist and essence of the present disclosure derived from the content described in the claims and equivalents thereof, various additions, substitutions, changes, partial deletions, or the like can be made to such embodiments. These embodiments may also be implemented in combination. For example, in the embodiments described above, the order of each of the operations or behaviors and the order of each of the processes are shown as examples, and the present invention is not limited to such operations and processes. The same applies to the case where numerical values or mathematical expressions are used in the description of the above-described embodiments.

1. A working system configured to perform a work by a working mobile body remotely operated by a user, comprising:
a head-mounted display configured to be worn by the user and provide the user with a virtual space image corresponding to a real space around the working mobile body; and
one or more processors that execute computer-executable instructions stored in a memory,
wherein the one or more processors execute the computer-executable instructions to cause the working system to:
generate the virtual space image corresponding to a position and a direction of the working mobile body.

2. The working system according to claim 1, wherein the one or more processors execute the computer-executable instructions to cause the working system to:
generate the virtual space image in which visual attraction of a work target area is enhanced in accordance with a work priority level.

3. The working system according to claim 1, wherein the one or more processors execute the computer-executable instructions to cause the working system to:
determine a working condition of the working mobile body; and
change the virtual space image in accordance with the working condition that has been determined.

4. The working system according to claim 3, wherein the one or more processors execute the computer-executable instructions to cause the working system to:
generate an acoustic signal; and
change, in accordance with the working condition, the acoustic signal that has been generated, and provide a sound corresponding to the acoustic signal to the user.

5. The working system according to claim 1, wherein the one or more processors execute the computer-executable instructions to cause the working system to:
generate a first virtual space image and a second virtual space image, the first virtual space image being the virtual space image corresponding to a case where a viewpoint is placed on the working mobile body, the second virtual space image being the virtual space image corresponding to a case where a viewpoint is placed outside the working mobile body; and
in a case of generating the second virtual space image, set a virtual object corresponding to the working mobile body, for the working mobile body in the second virtual space image.

6. The working system according to claim 1, wherein the one or more processors execute the computer-executable instructions to cause the working system to:
change the virtual space image in accordance with at least one of a total time obtained by adding up periods of time when the user operates the working mobile body, a total distance obtained by adding up distances that the user moves the working mobile body, a working characteristic of the user, or an operation characteristic of the user.

7. The working system according to claim 1, wherein the one or more processors execute the computer-executable instructions to cause the working system to:
generate an acoustic signal; and
change the acoustic signal that has been generated, in accordance with at least one of a total time obtained by adding up periods of time when the user operates the working mobile body, a total distance obtained by adding up distances that the user moves the working mobile body, a working characteristic of the user, or an operation characteristic of the user.

8. The working system according to claim 1, wherein the one or more processors execute the computer-executable instructions to cause the working system to:
award the user a point in accordance with the work performed by the working mobile body remotely operated by the user.

9. The working system according to claim 1, wherein the one or more processors execute the computer-executable instructions to cause the working system to:
predict whether or not the working mobile body contacts an obstacle; and
control the working mobile body so as to avoid contact between the working mobile body and the obstacle in a case that the contact between the working mobile body and the obstacle is predicted.

10. The working system according to claim 9, wherein the one or more processors execute the computer-executable instructions to cause the working system to:
deploy an airbag provided in the working mobile body in a case that the contact between the working mobile body and the obstacle is unavoidable.

11. The working system according to claim 1, wherein the one or more processors execute the computer-executable instructions to cause the working system to:
acquire image data configured to be used in generating the virtual space image through a network communication; and
generate the virtual space image using the image data that has been acquired.

12. The working system according to claim 4, wherein the one or more processors execute the computer-executable instructions to cause the working system to:
acquire acoustic data configured to be used in generating the acoustic signal through a network communication; and
generate the acoustic signal using the acoustic data that has been acquired.
